(19) United States
(12) Patent Application Publication
(10) Pub. No.: US 2014/0329237 A1
(43) Pub. Date: Nov. 6, 2014

(54) MEANS AND METHODS FOR ASSESSING SPERM NUCLEAR DNA STRUCTURE

(71) Applicants: Constantine Mallidis, Muenster (DE); Stefan Schlatt, Altenberge (DE); Joachim Wistuba, Bielefield (DE); Carsten Fallnich, Lehrte (DE); Petra Gross, Rheine (DE); Martin Burger, Muenster (DE); Frank Wuebbeling, Billerbeck (DE)

(72) Inventors: Constantine Mallidis, Muenster (DE); Stefan Schlatt, Altenberge (DE); Joachim Wistuba, Bielefield (DE); Carsten Fallnich, Lehrte (DE); Petra Gross, Rheine (DE); Martin Burger, Muenster (DE); Frank Wuebbeling, Billerbeck (DE)

(73) Assignee: Westfälische Wilhelms-Universität Münster, Münster (DE)

(21) Appl. No.: 14/352,682

(22) PCT Filed: Oct. 30, 2011
(86) PCT No.: PCT/EP2011/005492

§ 371 Date: Jul. 18, 2014

(51) Int. Cl. G01N 21/65

(52) U.S. Cl. CPC G01N 21/658
USPC 435/6.1

(57) ABSTRACT

The present invention is directed to a method for determining nuclear DNA (nDNA) in sperm sample by means of Raman micro-spectroscopy. In particular, the method is useful to determine the presence of intact and/or damaged nDNA in a sperm. Further, the present invention is directed to a method for screening sperm for in vitro fertilization or artificial reproduction treatment (ART).

### FIELD OF THE INVENTION

The present invention is directed to a method for assessing nuclear DNA (nDNA) in sperm sample by means of Raman micro-spectroscopy. In particular, the method is useful to determine the presence of intact and/or damaged nDNA in individual sperm. Further, the present invention is directed to a method for screening sperm for the various artificial reproduction treatments (ART).

### BACKGROUND

The introduction of molecular based analytical techniques has revolutionized andrological research and more importantly it has provided clues to the possible causes underlying that most vexing of conditions, “idiopathic” infertility. By necessity, this unsatisfactory diagnosis has been used to describe the large percentage of couples where the male partner is deemed normal, based on WHO semen criteria (World. Health Organisation 1999), yet is infertile. As a consequence of the lack of any identifiable cause(s), clinicians are limited in the therapeutic options which can be made available to these men.

With the rapid expansion in “omics” technology and methods, insights into the hitherto unknown genetic, transcriptional, metabolic and protein mechanisms underpinning male reproductive function have been obtained (Barratt et al. 2002, Mallidis et al. 2009a, Mallidis et al. 2009b, Oliva et al. 2008). Of the many putative causes thus far suggested for aberrant sperm function, nDNA damage is the most studied and is increasingly being acknowledged as a crucial factor affecting embryo quality, development and implantation (Henkel et al. 2003, Morris et al. 2002, Speyer et al. 2010). The identification, therefore, of sperm with intact nDNA is of great importance to the success of any artificial reproduction treatment (Benchaib et al. 2003, Duran et al. 2002, Tomlinson et al. 2001).

Although numerous methods (Fernandez et al. 2005, Giwercman et al. 2009, Muratori et al. 2008, Santiso et al. 2010, Shaposhnikov et al. 2009) are currently available for the measurement of sperm nDNA status, all are limited to measuring the extent of damage on a “characteristic” sample of the ejaculate and are of little use therapeutically as they render the assessed sample unsuitable for ART. Furthermore, none provide information that is directly applicable to the condition of a specific viable sperm nor can they decipher its ability to function correctly and hence produce a pregnancy. It is not surprising therefore that the Practice Committee of the American Society for Reproductive medicine should state that “. . . current methods for evaluating sperm integrity do not reliably predict treatment outcome” (Practice Committee of American Society for Reproductive Medicine 2008).

What is required is a non-invasive, non-destructive technique that provides accurate information on the status of a sperm's nuclear DNA, whilst not affecting the integrity of the cell, allows for its selection and ultimately use by intracytoplasmic sperm injection (ICSI).

Raman spectroscopy is a discrete laser scattering technique that provides detailed information on the internal structure of molecules which comprise the chemical “fingerprint” of a sample. Discovered more than 80 years ago, the molecular vibrational and rotational deformations detected by Raman have been used in a variety of disciplines to identify and classify substances of interest. With recent technological improvements, the method has been complemented by the three dimensional spatial resolution afforded by confocal microscopy so that it can now detect changes in and location of defined molecules (Swain and Stevens 2007). In medicine, these advances have led to its successful utilization in the discrimination, classification and diagnosis of pathological conditions such as different malignancies and tumours (Chowdary et al. 2006, Krishna et al. 2004, Vidyasagar et al. 2008). Being non-invasive it has also been employed in the investigation and analysis of various living cells (e.g. living bacteria and stem cells) providing specific data without any adverse reactions to the cells themselves (Downes et al. 2010, Schuster et al. 2000, Swain and Stevens 2007). Interestingly one of the first cells to be analysed using Raman was salmon sperm (Kubasek et al. 1986). Kubasek et al. reported that salmon sperm DNA has a B-type confirmation as assessed by Raman spectra.

Recently two studies have been published that employed the Raman spectroscopy technique on human sperm (Huser et al. 2009, Meister et al. 2010). Though applying Raman spectroscopy, both studies did not come up with a clue as how to use Raman spectroscopy for checking the quality of sperm DNA. Huser et al. drew the conclusion that Raman spectroscopy ids useful for checking quality of sperm by assessing their DNA packaging, while Meister et al. determined the mitochondrial and motility status in order to distinguish motile and non-motile and thus fertile from non-fertile sperm. In particular, Huser et al. (2009) contends that a large peak at 785 cm⁻¹ of the Raman spectrum obtained, which is attributed to the efficiency of protamine packing of DNA, is indicative of the normality of sperm and that after normalization to the DNA backbone shift at 1092 cm⁻¹, variations in the ratio of the 785 cm⁻¹/1442 cm⁻¹ peaks are predictive of normal morphology. The results however have not been confirmed.

In their spectral mapping, Meister et al. (2010) described two regions (“neck” and “midpiece”) that were not seen by further analyses. In Meister et al. (2010) the characterization of the neck was based on the presence of pronounced protein peaks, features seen in the spectra have been found throughout the tail. The “midpiece” attribution depended on the presence of two peaks: 751 cm⁻¹ described as a “dominant” feature of mitochondria and 1575 cm⁻¹ a shift they associate with ATP. The higher resolution spectra obtained in another study of the present inventor dispute the purported identification of a midpiece region as they show the 751 cm⁻¹ shift not to be a feature exclusive to mitochondria but rather an element present in spectra from all sperm regions. Furthermore, the 1575 cm⁻¹ peak was weak in the proposed “midpiece” but prominent in the head region, suggesting that the shift is due to the breathing mode of adenine and guanosine bases (as mentioned by Meister et al. 2010), and consistent with the presence of DNA, rather than the purported ATP found in mitochondria.

Given the fact that thus far to the best of the inventors' knowledge no method is available that allows assessing the quality of sperm nuclear DNA, there is a need for a non-invasive, non-destructive technique that provides accurate and/or readily understandable information on the status of a sperm's nuclear DNA, whilst not affecting the integrity of the cell, and that thus allows for selection of sperm and ultimately their use for intracytoplasmic sperm injection or in vitro fertilization.

The present invention provides thus means and methods for visualizing intact, partially damaged and/or damaged sperm nuclear DNA with the aim of distinguishing intact sperm (normal sperm cells) from partially damaged and/or damaged sperm (abnormal sperm cells) as described herein, exemplified in the appended Examples and mirrored in the claims.

It must be noted that as used herein, the singular forms “a”, “an”, and “the”, include plural references unless the context clearly indicates otherwise. Thus, for example, reference to “a reagent” includes one or more of such different reagents and reference to “the method” includes reference to equivalent steps and methods known to those of ordinary skill in the art that could be modified or substituted for the methods described herein.

All publications and patents cited in this disclosure are incorporated by reference in their entirety. To the extent the material incorporated by reference contradicts or is inconsistent with this specification, the specification will supersede any such material.

Unless otherwise indicated, the term “at least” preceding a series of elements is to be understood to refer to every element in the series. Those skilled in the art will recognize, or be able to ascertain using no more than routine experimentation, many equivalents to the specific embodiments of the invention described herein. Such equivalents are intended to be encompassed by the present invention.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein the term “comprising” can be substituted with the term “containing” or sometimes when used herein with the term “having”.

When used herein “consisting of” excludes any element, step, or ingredient not specified in the claim element. When used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms.

As described herein, “preferred embodiment” means “preferred embodiment of the present invention”. Likewise, as described herein, “various embodiments” and “another embodiment” means “various embodiments of the present invention” and “another embodiment of the present invention”, respectively.

Several documents are cited throughout the text of this specification. Each of the documents cited herein (including all patents, patent applications, scientific publications, manufacturer's specifications, instructions, etc.), whether supra or infra, are hereby incorporated by reference in their entirety. Nothing herein is to be construed as an admission that the invention is not entitled to antedate such disclosure by virtue of prior invention.

### DESCRIPTION OF THE INVENTION

The assays that are currently available for the assessment of nDNA status are broadly based on two principles, namely the incorporation of a substance that is able to bind differently to double or single stranded DNA and the electrophoretic dispersion of the compacted DNA. The first category includes the Acridine Orange Test (AOT) upon which is based the trademarked Sperm Chromatin Structure Assay (SCSA). Both these require the sperm to be processed and are dependent on the ability of acridine to bind to DNA. Problem is that the processing kills the sperm and acridine is a mutagen. Other methods of this category are TUNEL (terminal deoxynucleotidyl transferase-mediated-dUTP nick end labelling) which uses an enzyme to add labelled nucleotides to the damaged DNA and the Toluidine blue assay. Both have the same problems as AOT and SCSA.

The chromatin dispersion tests are even more destructive as they lyse the sperm membrane and then place the cells in an electric field so as to distinguish the fragments of DNA. The most common are the COMET (single cell gel electrophoresis) and the trademarked HaloSperm which is based on the same principle. The process needed by both these tests obliterates the sperm and renders them useless for any other purposes. Although all assays can decipher the status of a single sperm, results for all are given as a percentage of the sperm with damage in a said sampling (usually 5,000 for SCSA & AOT and 200 for COMET & Halosperm).

So in contrast to methods of the present invention, all the current techniques are destructive, invasive, cannot lead to selection and render the sperm unusable. Yet, the methods of the present invention overcome these drawbacks.

In fact, the present inventors have found a method for detecting sperm nuclear DNA (nDNA) in a sperm sample based on Raman microspectroscopy.

More specifically, in their studies and investigations the present inventors assessed the applicability of Raman microspectroscopy to the analysis of sperm nDNA integrity. Once optimized, they found the technique to be reproducible, reliable and the acquisition of spectra to be quick and easy. Accordingly, the present invention relates to such a technique. Importantly, the information obtained provided a detailed profile describing the DNA structure and/or status of a single sperm. The spatial distribution of the differing spectral profiles provided a map from which not only could the known features of a sperm head be readily distinguished, but also small anomalies such as vacuoles could be discerned. Moroever, the present inventors were able to interpret and analyse the spectra obtained by applying the then-methods of the present invention described herein, thereby indentifying specific regions that are to be evaluated such that damage of nuclear sperm DNA can be assessed as described herein. Once applied, differences in the spectra could be used to identify the presence of damaged DNA and once combined with the mapping feature gave an indication of the actual location of fragmented DNA within the sperm head.

Accordingly, the present invention thus provides accurate and reproducible assessments of DNA structure of sperm nuclear DNA and allows the identification and/or selection of damaged from undamaged sperm for use in the clinic.

The methods of the present invention are preferably useful to detect the presence of intact and/or damaged nDNA in sperm.

In a first aspect, the present invention provides a method for detecting sperm nuclear DNA (nDNA) in a sperm sample by Raman microspectroscopy, the method comprising

a) providing a sperm sample;

b) irradiating sperm with a laser beam;

c) collecting and collating the resulting Raman signals; and

d) obtaining the Raman spectrum.

“Providing” a sperm sample includes the provision and/or preparation of a sperm sample. A sperm sample can be used in its “native” state, i.e., also containing seminal plasma. However, it is preferred that the sperm sample is “washed” or “isolated”. A sperm can, for example, be washed as follows: diluting sperm in a suitable buffer such as PBS, centrifuging the diluted sperm sample, for example at 400 g for 10 min, removing the supernatant and resuspending the pellet in a suitable buffer such as PBS.

“Irradiating the sperm” means that preferably each sperm in the sperm sample is individually irradiated with a laser beam. The individual irradiation allows the assessment of the structure and/or status and/or integrity of a single sperm, thereby allowing deciding as to whether or not the sperm contains damaged, partially damaged or intact nuclear DNA. Accordingly, the beauty that the present invention can achieve is, so to say, an assessment on the spot of a single sperm for its structure and/or status and/or integrity of its nDNA. A sperm subjected to the methods of the present invention (which is preferably assessed as sperm with intact nDNA) is envisaged to be used for further processes such as IVF or ICSI. This is in sharp contrast to prior art methods such as those described in Huser et al . 2009 and Meister et al. 2010.

“Obtaining” (a) Raman spectrum/spectra includes that at least 1, more preferably 2, 3, 4, 5, 6, 7, 8, 9, 10, even more preferably 20, 30, 40, 50, 60, 70, 80, 90, 100, 200 spectra are obtained from a sperm sample.

The present inventors have identified several regions of the Raman spectrum of sperm that are indicative of the presence of intact and/or damaged nuclear DNA in the sperm. Preferably, the region of the Raman spectrum is at 1100 to 1020 cm⁻¹. Accordingly, it is generally preferred that a Raman spectrum obtained as described herein is evaluated for peaks as described herein in the region at 1100 to 1020 cm^{-1.}

Specifically, the present inventors have found that the presence of a main single peak in the region 1100 to 1070 cm⁻¹, preferably a peak at 1092 ±5 cm⁻¹, more preferably a peak at 1092 cm⁻¹ which is associated with DNA PO₄ backbone is indicative of an intact (non-damaged) nDNA.

They have further observed that the Raman spectrum of sperm containing damaged nDNA shows a shift of the main single peak of the region at 1100 to 1070 cm⁻¹, preferably of the peak at 1092 cm⁻¹ toward the region at 1050 to 1020 cm⁻¹. Preferably, the peak in the region at 1050 to 1020 cm⁻¹ is at 1042±5 cm⁻¹ more preferably at 1042 cm⁻¹.

The absence of the main peak in the region at 1050 to 1020 cm⁻¹, preferably of the peak at 1042±5 cm⁻¹, more preferably at 1042 cm⁻¹ is indicative of the absence of damaged nDNA in the sperm, while the presence of a main peak in the region at 1050 to 1020 cm⁻¹ preferably of a peak at 1042±5 cm⁻¹, more preferably at 1042 cm⁻¹ is indicative of the presence of damaged nDNA in the sperm.

The contemporaneous presence of a (the) main single peak in the region 1100 to 1070 cm⁻¹, preferably a peak at 1092±5 cm⁻¹, more preferably a peak at 1092 cm⁻¹ and the presence of a (the) main peak in the region at 1050 to 1020 cm⁻¹, preferably of a peak at 1042±5 cm⁻¹, more preferably at 1042 cm⁻¹ is indicative of the presence of intact and/or damaged and/or partially damaged nDNA in the sperm, respectively.

Without being bound to any theory, it seems that this shift is indicative of the vibrational changes resulting from modifications and dimerizations of nucleotide bases of the nDNA. Therefore, Raman spectra of sperm showing this shift are indicative of the presence of damaged nDNA in the sperm.

In sum, the present inventors have found that the presence of a main single peak in the region 1100 to 1070 cm⁻¹, preferably a peak at 1092±5 cm⁻¹, more preferably a peak at 1092 cm⁻¹ which is associated with DNA PO₄ backbone is indicative of an intact (non-damaged) nDNA, whereas the loss of intensity of the main single peak in the region at 1100 to 1070 cm⁻¹, preferably of the peak at 1092±5 cm⁻¹, more preferably of the peak at 1092 cm⁻¹ is indicative of the presence of damaged nDNA and/or partially damaged nDNA in the sperm.

The significance of the Raman shift between the Raman spectrum of a sperm sample containing only intact nDNA, a sperm sample containing only damaged nDNA, and a sperm sample containing damaged and intact nDNA can preferably be confirmed via Wavelet analysis. Wavelet analysis is useful to systematically identify local changes in the Raman spectra between the samples containing only intact nDNA and samples containing damage nDNA. (Mallat, 1999). Wavelet analysis and its use in Raman spectroscopy is known in the art.

In the methods of the invention, the sperm sample is irradiated/illuminated with a laser beam as a means of inducing the Raman effect. As explained above, it is preferred and thus an advantage of the methods of the present invention that a single sperm can be assessed as described herein. Typically, a sample is irradiated/illuminated with a laser beam in order in induce a Raman effect. More specifically, a single sperm is irradiated/illuminated with a laser beam. Light from the irradiated/illuminated sperm is collected with a lens and sent through a monochromator. Wavelengths close to the laser line, due to elastic Rayleigh scattering, are filtered out while the rest of the collected light is dispersed onto a detector. A preferred set up is described in the appended Examples; see Example 2.

The laser for Raman spectroscopy operated in the visible, infrared and near ultraviolet wavelength regions. Preferably the laser operates with a wavelength within a range of 500 nm-800 nm, including 500 nm-700 nm, 500-600 nm. Preferred wavelength is at 633 nm or at 785 nm. The most preferred wavelength is at 633 nm as it allows having a better intensity of the spectrum in a shorter acquisition time.

The laser applied in the Raman microspectrometry is preferably a He-Ne laser having a power of preferably 15 mW. However, any other laser suitable for inducing the Raman effect is suitable, too. The acquisition time for duplicate readings is preferably about 10 seconds, but may be shorter such as 9, 8, 7, 6, 5, 4, 3, 2, 1 second(s). Either one scan per sperm, preferably two scans per sperm are done.

The methods of the invention therefore further comprise the analysis of the Raman spectrum of the sperm sample obtained applying the method of the invention to determine whether the sperm sample contains intact and/or damaged and/or partially damaged nDNA. The analysis may be performed by comparing the spectrum of the sperm sample with the Raman spectra of other sperm samples previously assessed, wherein the relevant peaks for the purpose of determining the presence of intact and/or damaged and/or partially damaged nDNA have already been identified.

Preferably, the relevant peaks in the region 1100-1020 cm⁻¹ have already been identified as described above. These Raman spectra are therefore “standard” or “reference” spectra. Alternatively, without recurring to the comparison with standard spectra, the direct analysis of the Raman spectrum region of interest, in particular of the region 1100 to 1020 cm⁻¹ may be performed to determine the presence of the peaks of interest as describe above and therefore ultimately determining the presence of intact and/or damaged and/or partially damaged nuclear DNA in the sperm sample.

When evaluating the Raman spectrum obtained by the method of the present invention it is preferred that the significance of Raman shift between the Raman spectrum of the intact nDNA and the damage nDNA is performed with Wavelet analysis.

Preferably, given the findings of the present inventors, the method of the present invention is for assessing the structure and/or status of sperm nDNA and/or integrity of sperm nDNA.

The assessment of the structure, status or integrity of sperm nDNA includes localizing DNA damages by way of Raman microspectroscopy as described herein, in particular the analysis of the presence of a main single peak in the region 1100 to 1070 cm⁻¹, preferably a peak at 1092±5 cm⁻¹, more preferably a peak at 1092 cm⁻¹ which is associated with DNA PO₄ backbone which is indicative of an intact (non-damaged) nDNA and/or the analysis of the loss of intensity of the main single peak in the region at 1100 to 1070 cm⁻¹, preferably of the peak at 1092±5 cm⁻¹, more preferably of the peak at 1092 cm⁻¹ which is indicative of the presence of damaged nDNA and/or partially damaged nDNA in the sperm.

The assessment of the structure and/or status and/or integrity of sperm nDNA comprises preferably determining DNA damages, in particular changes of the DNA PO₄ backbone in sperm nDNA, nucleotide modifications and/or nucleotide dimerizations.

Preferably, the determination of damage in sperm nDNA allows distinguishing intact from damaged and/or partially damaged nDNA. The distinction is preferably achieved by the evaluation of the Raman spectrum/spectra obtained from sperm of a sperm sample as described herein.

Also, the method of the present invention is preferably for visualizing intact, damaged and/or partially damaged sperm nDNA. “Visualizing” includes localizing DNA damages in sperm nuclear DNA. DNA damages are localized by evaluating (a) Raman spectrum/Raman spectra as described herein.

Preferably, the assessment of the structure and/or status and/or integrity of sperm nDNA, the distinction of intact from damaged and/or partially damaged nDNA or the visualization intact, damaged and/or partially damaged sperm nDNA is based on the presence of a main single spectral peak in the region of 1100 cm⁻¹ to 1020 cm⁻¹ of the Raman spectrum is indicative of the presence of intact nDNA in the sperm. More preferably, the main single spectral peak is in the region between 1100 cm⁻¹ to 1080 cm⁻¹ is at 1092±5 cm⁻¹, preferably at 1092 cm⁻¹. Preferably, the presence of said main peak is associated with intact DNA PO₄ backbone.

Likewise, the presence of a main spectral peak a in the region of 1050-1020 cm⁻¹, preferably a main spectral peak at 1042 cm⁻¹ of the Raman spectrum is indicative of the presence of damaged nDNA in the sperm sample. The presence of said main peak is associated with damaged DNA PO₄ backbone.

Accordingly, is sum, the presence of a peak in the region of 1100 cm⁻¹ to 1080 cm⁻¹ and of a peak in the region at 1050-1020 cm⁻¹ of the Raman spectrum is indicative of the presence of intact and/or damaged (including partially damaged) nDNA in the sperm sample, respectively.

It is generally preferred that the method of the present invention allows selecting normal from abnormal sperm comprised by a sperm sample on the basis of intact, damaged and/or partially damaged nDNA. A sperm is regarded as being normal, if it has intact nDNA as determined by the methods of the present invention, whereas a sperm is regarded as being abnormal if it has damaged and/or partially damaged nDNA as determined by the methods of the present invention. The selection is preferably done by evaluating Raman spectra obtained from a sperm sample in the region of 1020-1100 cm⁻¹ of the Raman spectra.

As described herein, the presence of a main single spectral peak in the region of 1100 cm⁻¹ to 1020 cm⁻¹ of the Raman spectrum is indicative of the presence of intact nDNA in the sperm. More preferably, the main single spectral peak is in the region between 1100 cm⁻¹ to 1080 cm^{-1 is at} 1092±5 cm⁻¹, preferably at 1092 cm⁻¹. Preferably, the presence of said main peak is associated with intact DNA PO₄ backbone.

Likewise, the presence of a main spectral peak a in the region of 1050-1020 cm⁻¹, preferably a main spectral peak at 1042 cm⁻¹ of the Raman spectrum is indicative of the presence of damaged nDNA in the sperm sample. The presence of said main peak is associated with damaged DNA PO₄ backbone.

Accordingly, is sum, the presence of a peak in the region of 1100 cm⁻¹ to 1080 cm⁻¹ and of a peak in the region at 1050-1020 cm⁻¹ of the Raman spectrum is indicative of the presence of intact and/or damaged (including partially damaged) n DNA in the sperm sample, respectively.

In view of the findings of the present inventors as explained above, it is generally preferred that in the method of the present invention the presence of a peak in the region of 1100 cm⁻¹ to 1080 cm⁻¹ and of a peak in the region at 1050-1020 cm⁻¹ of (a) Raman spectrum/spectra obtained by the methods of the present invention is indicative of the presence of intact and/or damaged (including partially damaged) nDNA in the sperm sample.

In particular, in the method of the present invention it is preferred that the presence of a main single spectral peak in the region of 1100 cm⁻¹ to 1020 cm⁻¹ of the Raman spectrum obtained in step d) is indicative of the presence of intact nDNA in the sperm. In contrast, it is preferred that the presence of two or more neighboring peaks in the same region are indicative of the presence of damaged and/or partially damaged nDNA in the sperm.

More preferably, the main single spectral peak is in the region between 1100 cm⁻¹ to 1080 cm⁻¹ is at 1092±5 cm⁻¹, preferably at 1092 cm⁻¹. Likewise, the two or more neighboring peaks are that are indicative of the presence of damaged and/or partially damaged nDNA in the sperm are again preferably in the same region.

In view of the foregoing explanations, in a preferred aspect, the present invention provides a method for visualizing intact and/or damaged and/or partially damaged sperm nuclear DNA in a sperm sample by Raman microspectroscopy, the method comprising

a) providing a sperm sample;

b) irradiating sperm with a laser beam;

c) collecting and collating the resulting Raman signals; and

d) obtaining the Raman spectrum,

wherein the presence of a (the) main single peak in the region 1100 to 1070 cm⁻¹, preferably a peak at 1092±5 cm⁻¹, more preferably a peak at 1092 cm⁻¹ and/or the presence of a (the) main peak in the region at 1050 to 1020 cm⁻¹, preferably of a peak at 1042±5 cm⁻¹, more preferably at 1042 cm⁻¹ is indicative of the presence of both intact and/or damaged and/or partially damaged nDNA in the sperm.

In view of the foregoing explanations, in a preferred aspect, the present invention provides a method for assessing the structure and/or status and/or integrity of sperm nDNA by Raman microspectroscopy, the method comprising

a) providing a sperm sample;

b) irradiating sperm with a laser beam;

c) collecting and collating the resulting Raman signals; and

d) obtaining the Raman spectrum,

wherein the presence of a (the) main single peak in the region 1100 to 1070 cm⁻¹, preferably a peak at 1092±5 cm⁻¹, more preferably a peak at 1092 cm⁻¹ is indicative of a structure, status or integrity that is normal (i.e. intact sperm nDNA) and/or the presence of a (the) main peak in the region at 1050 to 1020 cm⁻¹, preferably of a peak at 1042±5 cm⁻¹, more preferably at 1042 cm⁻¹, is indicative of a structure, status or integrity that is not normal (i.e. damaged and/or partially damaged sperm nDNA).

Also, in view of the foregoing explanations, in a preferred aspect, the present invention provides a method for determining DNA damages, in particular changes of the DNA backbone, nucleotide modifications and/or dimerizations by Raman microspectroscopy, the method comprising

a) providing a sperm sample;

b) irradiating sperm with a laser beam;

c) collecting and collating the resulting Raman signals; and

d) obtaining the Raman spectrum,

wherein the presence of a (the) main single peak in the region 1100 to 1070 cm⁻¹, preferably a peak at 1092±5 cm⁻¹, more preferably a peak at 1092 cm⁻¹ and/or the presence of a (the) main peak in the region at 1050 to 1020 cm⁻¹, preferably of a peak at 1042±5 cm⁻¹, more preferably at 1042 cm⁻¹ is indicative of the presence of both intact and/or damaged and/or partially damaged nDNA in the sperm.

Furthermore, in view of the foregoing explanations, in a preferred aspect, the present invention provides a method for selecting normal from abnormal sperm, the method comprising

a) providing a sperm sample;

b) irradiating sperm with a laser beam;

c) collecting and collating the resulting Raman signals; and

d) obtaining the Raman spectrum,

wherein the presence of a (the) main single peak in the region 1100 to 1070 cm⁻¹, preferably a peak at 1092±5 cm⁻¹, more preferably a peak at 1092 cm⁻¹ and/or the presence of a (the) main peak in the region at 1050 to 1020 cm⁻¹, preferably of a peak at 1042±5 cm⁻¹, more preferably at 1042 cm⁻¹ is indicative of the presence of normal sperm having intact nDNA and/or abnormal sperm having damaged and/or partially damaged nDNA.

Also, the present invention relates to a method for determining as to whether sperm nDNA is intact, damaged and/or partially damaged by performing the method steps a) to d) as described herein and, optionally, also method steps e) and f). The determination is preferably made as described herein, i.e., by the evaluation of the region 1020-1100 cm⁻¹ of (a) Raman spectrum/spectra.

It is envisaged that the sperm subjected to the methods of the present invention may be intact, damaged and/or partially damaged. Accordingly, as explained herein, the methods of the present invention allow distinguishing intact, damaged and/or partially damaged sperm.

In a preferred embodiment, the methods of the present invention further comprise

e) comparing the spectrum obtained in step d) with comparative Raman spectra of intact sperm and/or damaged and/or partially damaged nDNA; and

f) determining whether the nDNA of the sperm sample is intact and/or damaged and/or partially damaged as described herein.

Preferably, in step f) the evaluation of the region 1020-1100 cm⁻¹ of the Raman spectra is performed.

It is likewise preferred, that in step f) the evaluation of the region of 1100 cm⁻¹ to 1080 cm⁻¹ and of a peak in the region at 1050-1020 cm⁻¹ of the Raman is performed.

In particular, the presence of a peak in the region of 1100 cm⁻¹ to 1080 cm⁻¹ and of a peak in the region at 1050-1020 cm⁻¹ of the Raman spectrum is indicative of the presence of intact and/or damaged (including partially damaged) nDNA in the sperm sample, respectively.

Having described the main single spectral peak in the region of 1100 cm⁻¹ to 1020 cm⁻¹ of the Raman spectrum obtained in step d) of the method of the present invention, it is likewise preferred that the presence of a main spectral peak in the region of 1050-1020 cm⁻¹, preferably a main spectral peak at 1042 cm⁻¹ of the Raman spectrum obtained in step d) is indicative of the presence of damaged (including partially damaged) nDNA in the sperm sample, whereas the presence of a main single spectral in the region between 1100 cm⁻¹ to 1080 cm⁻¹, preferably at 1092±5 cm⁻¹, more preferably at 1092 cm⁻¹ is indicative of the presence of intact nDNA in the sperm sample.

Generally, damaged DNA is preferably characterized by DNA backbone breaks (single and/or double strand breaks, modified nucleotides, nucleotide dimers and the like).

Accordingly, it is preferred that the presence of the main peak in the region of 1100 cm⁻¹ to 1020 cm⁻¹ of the Raman spectrum obtained in step d) is associated with damaged DNA, in particular with damaged DNA PO₄ backbone.

In a second aspect, the present invention provides a method for screening sperm for in vitro fertilization (or artificial reproduction treatment or ICSI), said method comprising determining intact or damaged or partially damaged nDNA according to a method of any of the preceding claims, wherein an intact nDNA indicates sperm suitable for in vitro fertilization (or artificial reproduction treatment) and a damaged nDNA indicates that the sperm is not suitable for in vitro fertilization (or artificial reproduction treatment).

The term “in vitro fertilization” refers to any technique for artificial reproduction treatment such as IVF, ICSI. The screening method of the invention comprises determining whether the nDNA of a sperm sample is intact and/or damaged according to a method for determining nDNA of the invention as indicated above. The absence of damaged nDNA indicates sperm suitable for in vitro fertilization and the presence of a damage nDNA indicates that the sperm sample is not suitable for in vitro fertilization.

It is generally envisaged that the methods of the present invention are performed with live sperm. Live sperm can be subjected to a further selection process, thereby allowing the distinction of normal from abnormal sperm cells, whereby intact sperm may be used for in vitro fertilization.

When the sperm sample on which the Raman spectroscopy is performed is viable and is considered to be suitable for in vitro fertilization, (e.g. due to the absence of damaged nDNA), it can be directly used for in vitro fertilization.

The term “sperm” when used herein includes, but is not limited to, sperm including motile and in-motile sperm and spermatozoons.

Spermatogenesis is the process by which germ cells replenish themselves and concurrently undergo division. Each spermatogonium divides to produce two primary spermatocytes from which two secondary spermatocytes are derived. Each spermatocyte divides to produce two spermatids, the cell stages where the shape and structure of the sperm are produced. Released from the testes, the sperm are stored in the epididymis where they obtain the ability to move and their DNA is further compacted. It is these cells that are the mature gametes. All of the aforementioned stages of sperm are included by the term “sperm” when used herein. Accordingly, when reference to sperm is made herein any of the aforementioned terms is intended to be meant, e.g., sperm including motile and in-motile sperm, spermatozoons.

Said term also refers to a single sperm as well as to a multitude a sperm. However, as mentioned above, the beauty of the present invention is that it allows the assessment of a single sperm. Accordingly, it is preferred that the methods of the present invention are capable of being performed on a single sperm that is comprised in a multitude of sperm.

In various preferred embodiments, the sperm subjected to the methods of the present invention is of a (male) mammalian, bird, fish, amphibian or reptile. It may also be of a (male) mammalian, bird, fish, amphibian or reptile that is no longer alive, while the sperm may be such a s a dinosaur. The sperm may also be from an insect or spider.

The mammalian is preferably (a male) human, cattle, bull, dog, cat, swine, horse, camel, sheep, goat, gazelles, rodent, etc.

The bird is preferably selected from (male) turkey, chicken, fowl.

Any Raman spectroscopy is suitable for the present purpose. Preferably, Confocal Raman Microscopy is used in the method of the present invention.

In a preferred embodiment, in the method of the present invention a single point scanning of the sperm is performed, more preferably two scans per sperm are performed.

In various preferred embodiments, when the wavelength of the laser is 633 nm the sample is irradiated wherein when the wavelength is 633 nm the sample is irradiated one or two times between 5 and 10 seconds.

In a third aspect, the present invention relates to a kit or system for performing the method of any one of the preceding claims. The kit or system comprises a device suitable for performing the methods of the present invention as well as further means and methods for performing the methods described herein such as containers, buffers, vials and the like. It is preferred that the kit or system contains an instruction manual as how to perform the methods of the present invention.

In a fourth aspect, the present invention relates to the use of Raman microspectroscopy for the purposes of the methods as described herein, e.g.,

for detecting sperm nDNA in a sperm sample;

for assessing the structure, status and/or integrity of sperm nDNA;

for visualizing intact, damaged and/or partially damaged sperm nDNA;

for determining DNA damages in sperm nDNA;

for localizing DNA damages in sperm nDNA;

for distinguishing intact from damaged and/or partially damaged sperm nDNA based on intact and/or damaged sperm nDNA; and/or for selecting normal from abnormal sperm cells based on intact and/or damaged sperm nDNA.

Given that, the present invention relates specifically to the use of Raman microspectroscopy for determining as to whether sperm nDNA is intact, damaged and/or partially damaged.

All definitions, embodiments, examples, etc. described in the context of the methods of the present invention apply, mutatis mutandis, to the third and fourth aspect of the present invention.

### FIGURES

The Figures show:

FIG. 1 shows the characteristic Raman spectra of suprasil glass (black), the tail (flagellum) region (blue), acrosome (Acrosome, green) and DNA in the human sperm head (red) (A). When the same colours were used to indicate the location of each of these chemical signatures in a macro map (i.e. one spectrum every 50 nm across the whole head region of a sperm), a hyperspectral representation (B) was obtained that closely resembled the features of the sperm (inset). The discrimination of the image was such that small irregularities in the sperm head such as vacuoles (yellow circles) were distinguishable based solely on the presence of differing spectra.

FIG. 2 shows the principle component analysis (A) showing little variation in the measurements obtained by the two observers (red, blue) for the untreated human sperm samples and clear distinction between both sets of findings for the untreated and those for UVB-irradiated sperm (green). Local spectral angle analysis (B) of the 1042 cm¹ peak as measured by two observers (red, green) from an untreated sample and that obtained from the corresponding UVB-damaged sample (blue). Clustering of the spectral angles close to zero for the untreated samples shows a uniformity of shape (i.e. similarity of reading and composition of sperm) in contrast to the distribution of the UVB-irradiated sample, which shows distinct difference between it and the untreated sample as well as a large variation in the cells that comprise the sample.

FIG. 3 is the local spectral angle analysis of two samples (red, blue) showing similar distribution and range prior to treatment (A) indicating little difference between samples from different men. Once irradiated, local spectral angle analysis of the corresponding samples (B) indicates that not only were both damaged by the treatment but also the difference in extent and therefore susceptibility to damage of the two samples.

FIG. 4 is the averaged spectra (A) showing the distinct shift at 1042 cm⁻¹ (arrow) in spectra of irradiated (red) compared with that of the untreated human sperm (green). The significance of this shift (arrow) was confirmed by Wavelet analysis (B), in a plot of the kurtosis of wavelet coefficient distributions of untreated and UVB irradiated sperm at small scales versus the Raman shift.

FIG. 5 is the overlay of human sperm showing the locations of spectra found to be indicative of intact (purple) and damaged (aqua) DNA.

FIG. 6 shows Raman spectra of the sperm samples using a laser beam at 633 nm and 785 nm.

FIG. 7 shows Raman spectra of sperm sample using a laser beam at 633 nm with laser power at 1, 25, 50 and 100%.

FIG. 8 shows Raman spectra of sperm samples using different focal points.

FIG. 9 is the comparison of spectra of washed compared to native sperm showed a higher overall resolution of Raman shifts as well as the absence of peaks at 714 cm⁻¹ and 1000 cm⁻¹ and a higher resolution of shifts between 1300-1450 cm⁻¹.

FIG. 10 shows the reproduction of the Huser et al. (2009) two dimensional distribution plot performed by the present inventors.

### EXAMPLES

1. Subjects

Eight healthy donors provided semen samples after 2-5 days of sexual abstinence. Light microscopic analysis according to WHO recommendations (World Health Organisation 1999) showed all parameters to be above normal limits. Samples were divided into two, half were kept in seminal plasma (“native”), the remainder were diluted in excess PBS, centrifugated at 400 g for 10 minutes, the supernatant removed and the pellet resuspended in fresh PBS (“washed”). Half of the washed sample was then exposed to 312 nm UV irradiation (Saur GmbH, Reutlingen, Germany) 10 minutes, the other half was left untreated. All aliquots were frozen in liquid nitrogen and stored prior to use. The success of the UVB treatment (>99.8% of sperm showed nDNA damage) was determined using the acridine orange test performed as previously described (O'Neill et al. 2010)

2. Confocal Raman Microspectroscopy

Analyses were performed on air dried sperm smears on suprasil microscope slides. 200 sperm/sample/treatment in backscattering geometry were analysed using LabRAM Aramis (HORIBA Jobin Yvon S.A.S, Lille, France), a dispersive system with automatically interchangeable Rayleigh rejection filters, Olympus BX41 microscope, four motorized interchangeable diffraction gratings and a Peltier-cooled, open electrode CCD detector operating at −70° C. Spectra were acquired at 460 mm focal length, 600 grooves/mm diffraction grating and 632.8 nm He—Ne laser (˜15 mW). A 100 μm entrance slit allowing pixel resolution of 2.2 cm⁻¹/CCD pixel and spectral resolution of 6.7 cm⁻¹ at 632.8 nm. Accumulation times were 2×5s for mapping, 2×10 s for single spectra. DuoScan™ maps were of single point 100 nm steps across 6.2×6.5 μm². For all measurements confocal mode (200 μm pinhole) was used with Olympus 100× objective (NA=0.9) at 210 μm working distance. Wavenumber was calibrated automatically by LabSpec 5 software using zero order line and Si line of a Si reference sample. Spectra were automatically corrected by the instrument's ICS response correction. Raman images were created by supervised modelling (LabSpec 5 software) function using four components. Each component was generated by using the mean spectrum of a distinct area within the mapped sperm and the substrate material. Each sample was measured independently by 2 observers who randomly selected sperm for assessment. Peak assignments were based on the attributions of (Huser et al. 2009, Meister et al. 2010).

3. Sample averages

A high-pass filter was conducted on each spectrum comprising a treatment group. In this manner, the smallest 10 cosine modes were deleted and any low-frequency background noise present in the original signal was eliminated. The optimized spectra for each group were averaged with the mean spectrum from each untreated sample being taken as the ‘reference’ spectrum. The spectral differences resulting from UV treatment were identified by the comparison of the mean spectra of the sperm from an irradiated sample with the corresponding reference (i.e. untreated) spectrum.

4. Principal Component Analysis

Standard PCA was performed on the data from all three measurements (observer M, observer W and UVB) Scores from first two principal components accounted for 25% of data and clearly separated UV irradiated from non-treated. Visual inspection of principal components and averaged Raman data were conducted to determine major peaks.

5. Local Spectral Angles

Based on the most significant shift change, local analysis of spectra was performed and the mean of each local spectrum was subtracted for normalization. The spectral angles between the average of the sample and that of all spectra, was then computed. An analogous comparison was carried out between two untreated and two UVB irradiated samples. The average was computed over the first comparison and then spectral angles as described above were computed.

6. Wavelet Analysis

To systematically identify local changes in the Raman spectra between the original and the UV damaged samples, a multiscale analysis based on wavelet decomposition was used. The rationale being, that differences at a certain scale and location in the spectra, would relate to specific wavelet coefficients. Daubechies2 Wavelet (standard implementation in MATLAB Wavelet Toolbox) to investigate the distribution of the wavelet coefficients provided similar findings to other available options (e.g. Haar Wavelet),It was hypothesized that the distribution will not be centered if a significant change occurs due to damage and the standard deviation, skewness, kurtosis, and differences of mean and median were computed.

7. System Optimisation

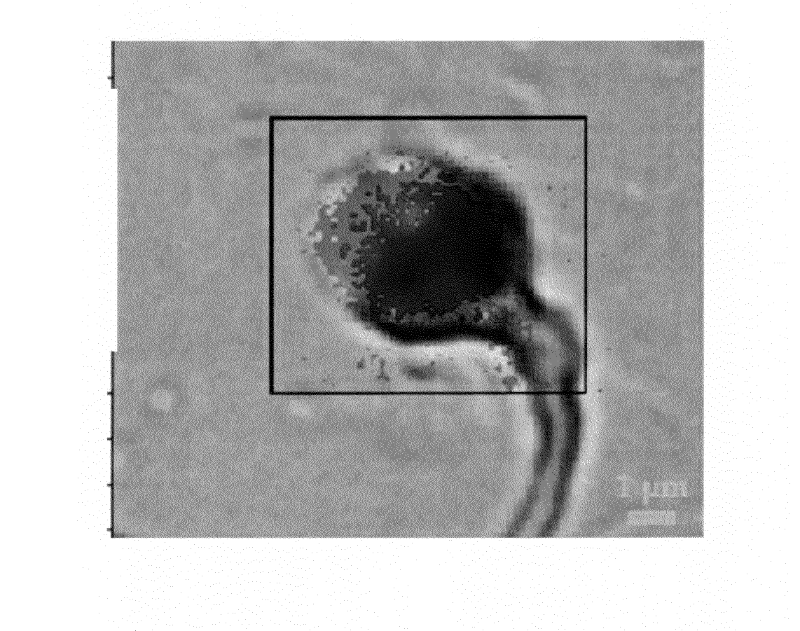

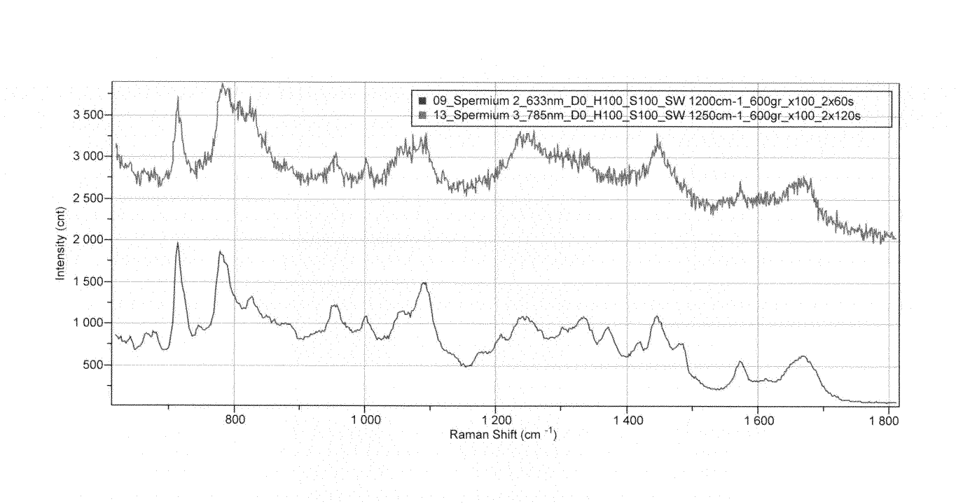

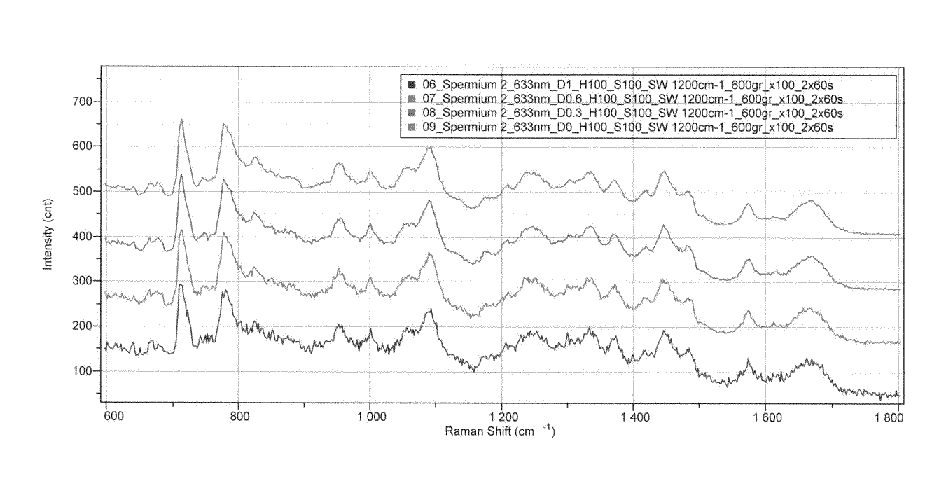

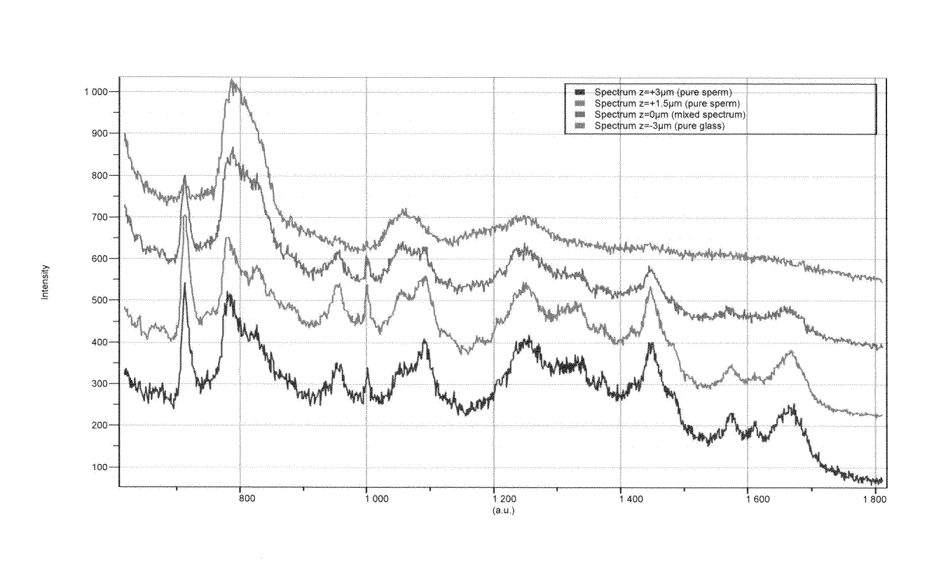

Comparison of the laser excitation wavelength showed that 633 nm provided a better signal to noise (S/N) ratio and hence clearer spectra than the two times more powerful 785 nm laser. Furthermore the better 633 nm spectra were obtained at half the acquisition time of the 785 nm (FIG. 6). To assess the sensitivity of sperm to 633 nm, the laser's power was varied at 1%, 25%, 50% and 100%. Other than an improved S/N ratio at maximum power, the Raman shifts obtained were identical indicating no laser induced damage (FIG. 7). For sperm to be damaged, the laser needed to be concentrated on a single spot for 10-30 minutes at full power. Variation of confocal apperture (i.e. 100, 200, 400, 1000 μm) showed that the greater the amount of light entering the detector the better the S/N however this substantially decreased the discrimination between the spectra originating from the sperm and that of the underlying glass slide. This problem was circumvented by setting the focal point of the laser at 3 μm ((FIG. 8)

8. Spectra and Mapping

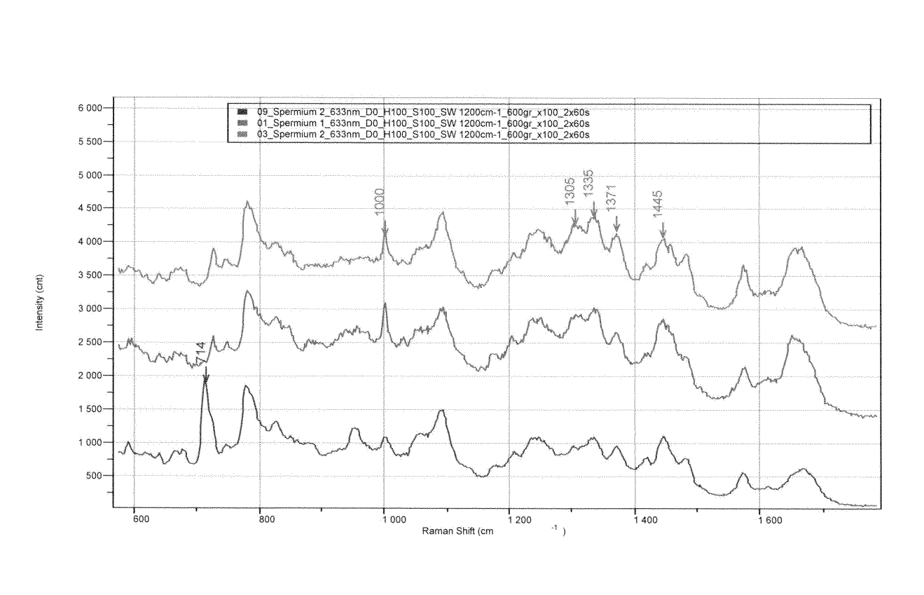

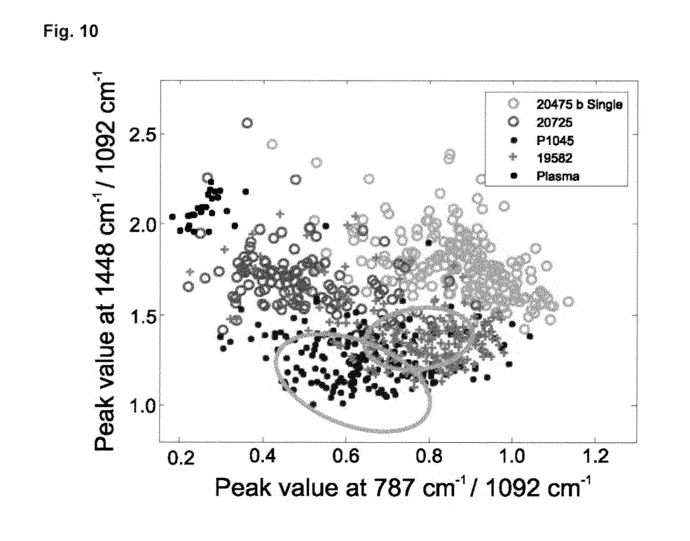

Spectra of seminal plasma showed three broad regions of overlayed peaks between 820-850 cm¹, 1010-1100 cm⁻¹ and 1220-1350 cm⁻¹. Particularly prominent were five peaks (714 cm⁻¹, 955 cm⁻¹, 1000 cm⁻¹, 1447 cm⁻¹ and 1666 cm⁻¹) consistent with the presence of proteins. Comparison of spectra of washed compared to native sperm showed a higher overall resolution of Raman shifts as well as the absense of peaks at 714 cm⁻¹ and 1000 cm⁻¹ and a higher resolution of shifts between 1300-1450 cm¹ (FIG. 9). As a consequence, only washed sperm were assessed in all subsequent experiments.

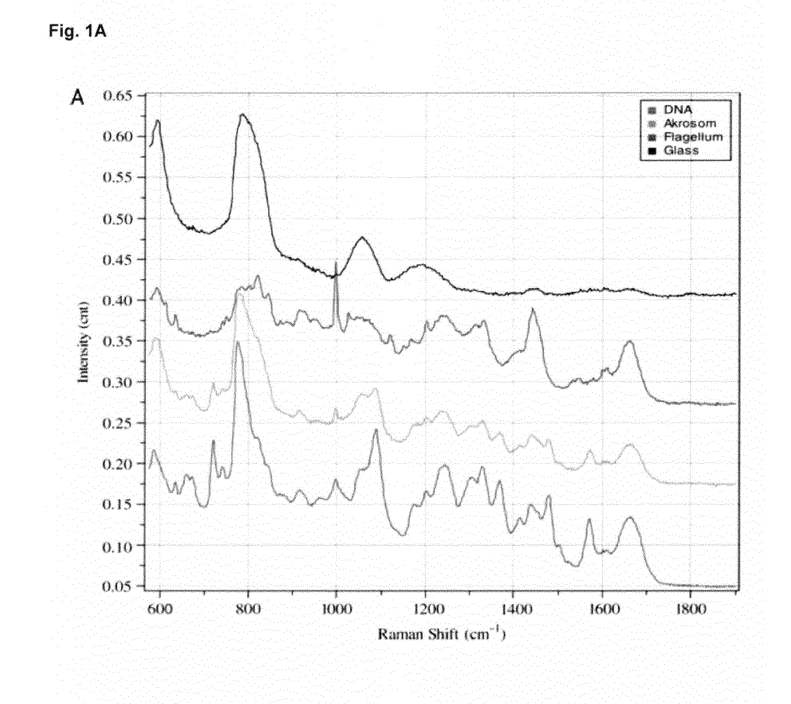

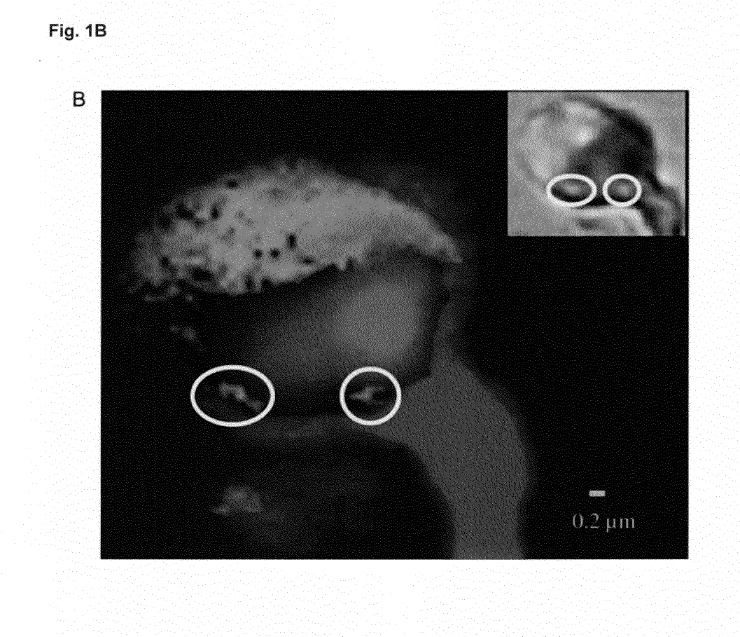

Single point scanning of sperm produced three distinct chemical profiles corresponding to the proximal head, the distal head and the tail (FIG. 1A). A sharp peak at 1000 cm⁻¹ attributable to thymidine was seen only in the spectra from the tail this together with the sharp 1447 cm⁻¹ methylene deformation peak are consistent with the presence of protein. The other two spectra contained a prominent 785 cm⁻¹ peak associated with tyrosine, cytosine and the DNA backbone but only the posterior head segment contained a peak at 1092 cm⁻¹ which is indicative of the PO₂⁻ backbone.

Composite macro mapping based on the location of each spectrum a provided a depiction of the sperm head delineating not only the distribution of DNA and protein in the head, acrosome and tail but also detecting small discrepancies such as vacuoles (FIG. 1B).

9. Spectral Analysis

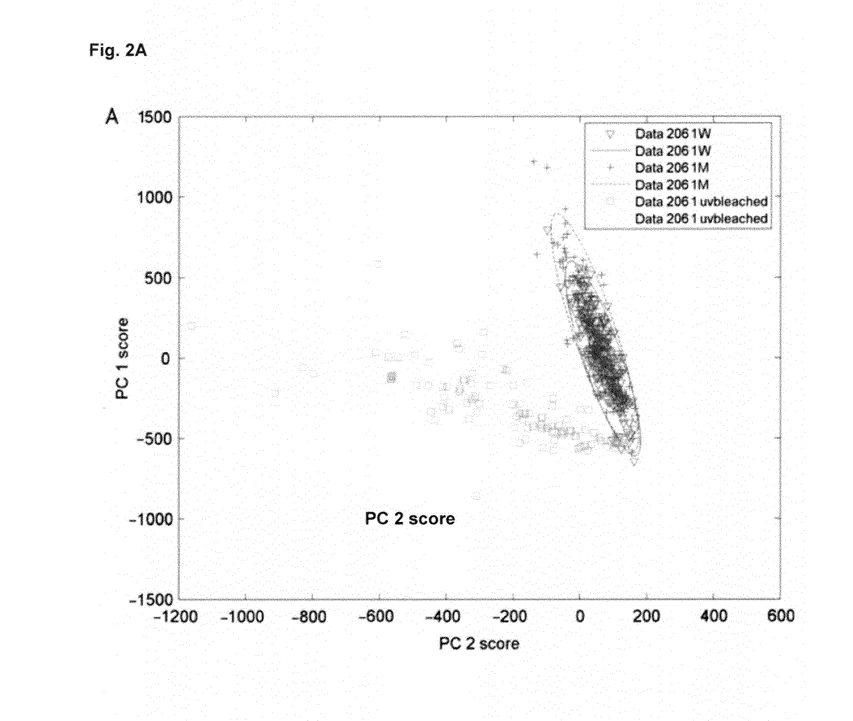

Principal component scoring analyses (FIG. 2A) showed that spectra from native samples were clearly distinguishable and significantly different from those obtained after UVB irradiation. No difference was seen between the different observers' measurements. Local spectral angle analysis (FIG. 2B), focussing on differences in the main spectral peak associated with the DNA PO₄ backbone (1092 cm⁻¹), showed a clear shift towards 1042 cm⁻¹ after treatment, a difference indicative of the vibrational changes resulting from modifications and dimerisations of nucleotide bases caused by UVB. The analysis also confirmed the lack of difference in the different observers' measurements.

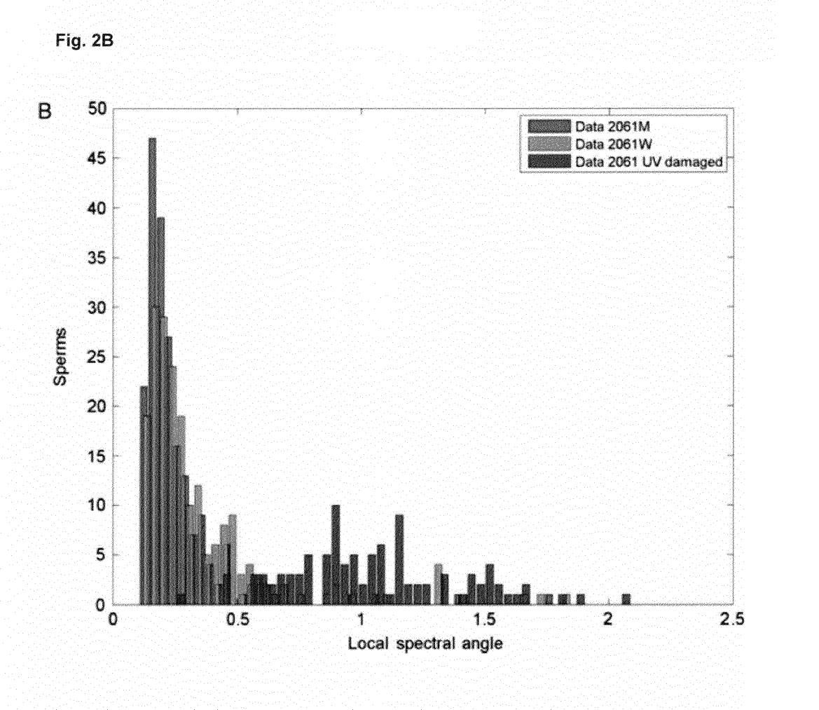

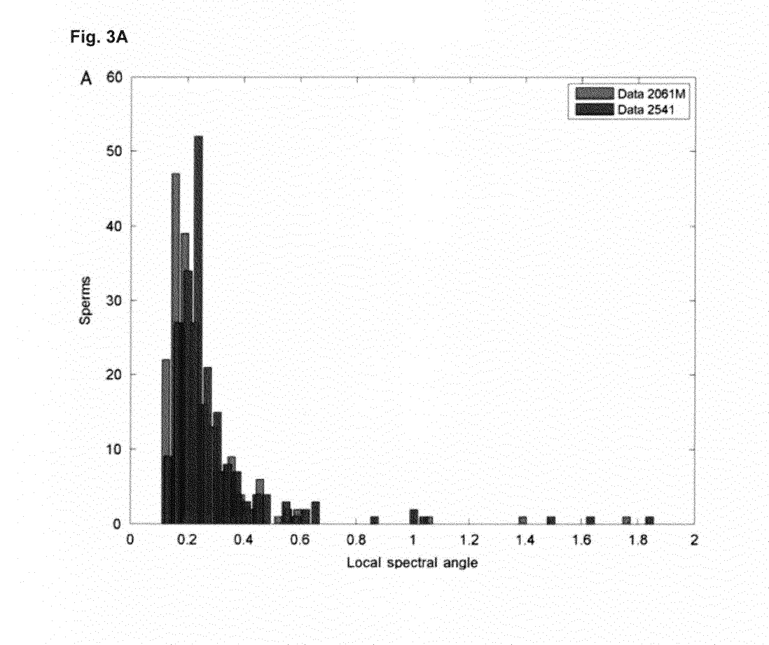

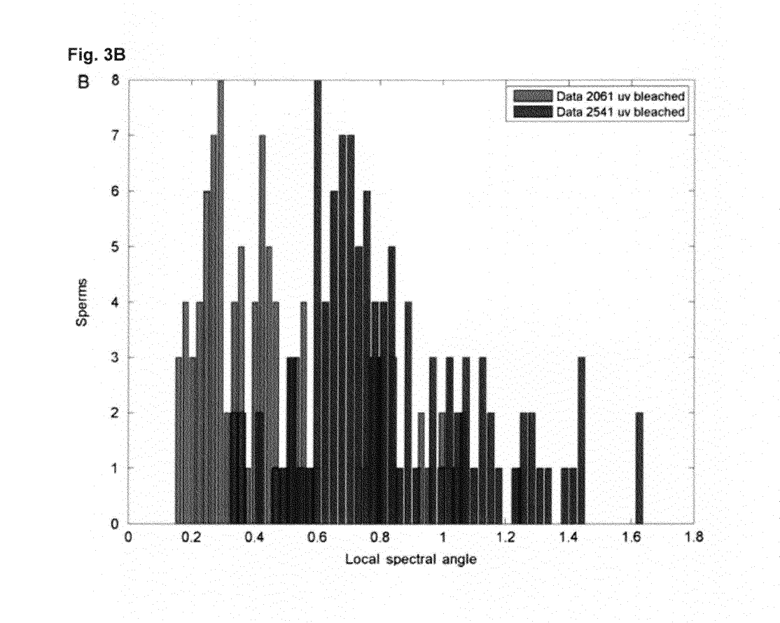

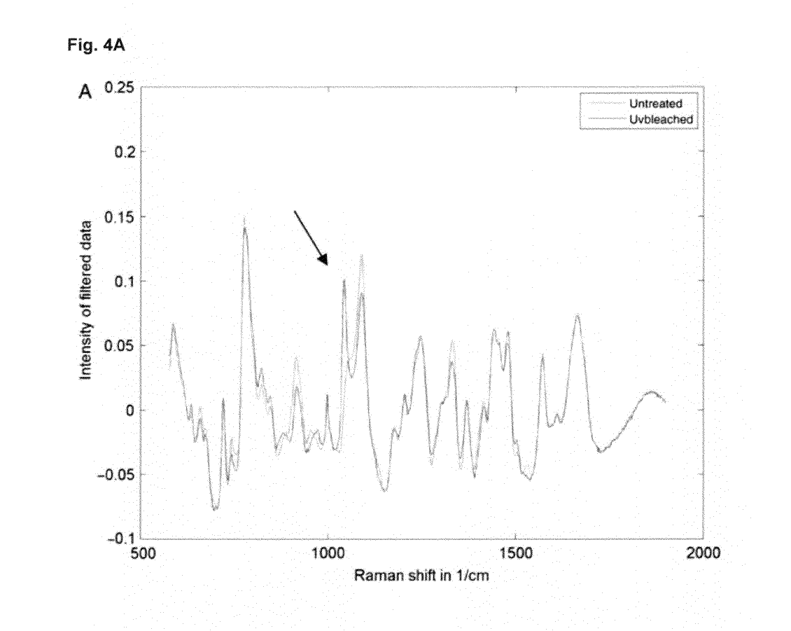

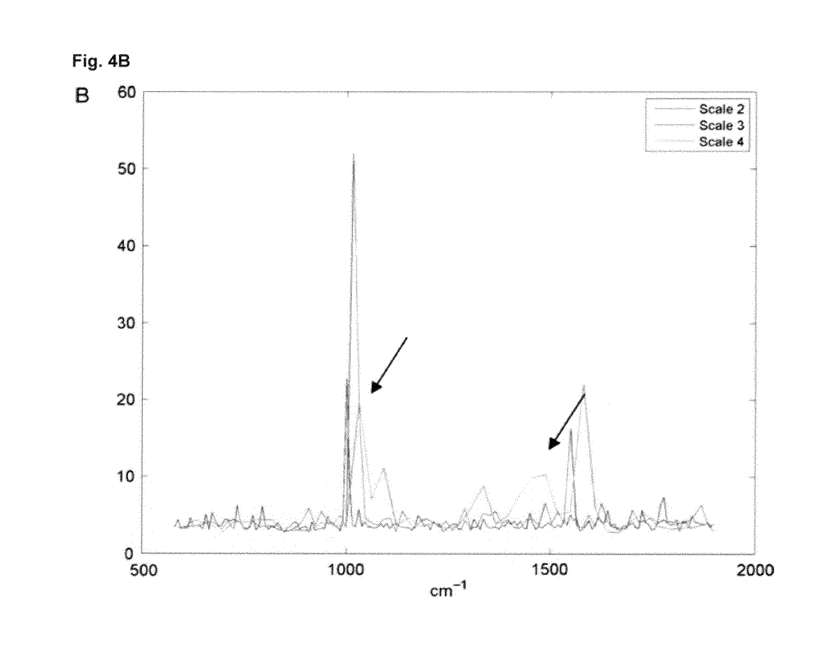

The degree and diversity of the changes to the backbone whether amongst untreated (i.e. inherent damage) or irradiated (i.e. induced damage) samples was clearly distinguishable by local spectral angles (FIG. 3). Closer examination of finer spectral differences using wavelet decomposition (FIG. 4) confirmed the 1042 cm⁻¹ shift and identified a possible second affected region (1400-1600 cm⁻¹) corresponding to protein-DNA interactions and thus susceptible to UVB damage. Using PCA components derived from spectra of UV-irradiated samples, an overlay of the score with respect to the main component allowed for visualisation of the distribution of damaged and undamaged DNA. It clearly showed that the consequences of UVB irradiation are not homogenous throughout the sperm nucleus but are predominantly in the periphery, particularly under the acrosomal cap (FIG. 5).

### REFERENCES

Avendano C, Franchi A, Taylor S, Morshedi M, Bocca S and Oehninger S. Fragmentation of DNA in morphologically normal human spermatozoa. Fertil Steril 2009:91:1077-1084.
Barratt C L, Hughes D C, Afnan M and Brewis I A. Functional genomics in reproductive medicine. Hum Fertil (Camb) 2002:5:3-5.
Benchaib M, Braun V, Lornage J, Hadj S, Salle B, Lejeune H and Guerin J F. Sperm DNA fragmentation decreases the pregnancy rate in an assisted reproductive technique. Hum Reprod 2003:18:1023-1028.
Bungum M, Bungum L and Giwercman A. Sperm chromatin structure assay (SCSA): a tool in diagnosis and treatment of infertility. Asian J Androl 2010:.
Cadet J, Sage E and Douki T. Ultraviolet radiation-mediated damage to cellular DNA. Mutat Res 2005:571:3-17.
Centers of Disease Control and Prevention Annual ART reports 2009 http://www.cdc.gov/art/ARTReports.htm
Chowdary M V, Kumar K K, Kurien J, Mathew S and Krishna C M. Discrimination of normal, benign, and malignant breast tissues by Raman spectroscopy. Biopolymers 2006:83:556-569.
de Mouzon J, Goossens V, Bhattacharya S, Castilla J A, Ferraretti A P, Korsak V, Kupka M, Nygren K G, Nyboe Andersen A and European IVF-monitoring (EIM) Consortium, for the European Society of Human Reproduction and Embryology (ESHRE). Assisted reproductive technology in Europe, 2006: results generated from European registers by ESHRE. Hum Reprod 2010:25:1851-1862.

Downes A, Mouras R and Elfick A. Optical spectroscopy for noninvasive monitoring of stem cell differentiation. Journal of Biomedicine & Biotechnology 2010:2010:101864.
Duran E H, Morshedi M, Taylor S and Oehninger S. Sperm DNA quality predicts intrauterine insemination outcome: a prospective cohort study. Hum Reprod 2002:17:3122-3128.
Fernandez J L, Muriel L, Goyanes V, Segrelles E, Gosalvez J, Enciso M, LaFromboise M and De Jonge C. Simple determination of human sperm DNA fragmentation with an improved sperm chromatin dispersion test. Fertil Steril 2005:84:833-842.
Giwercman A, Lindstedt L, Larsson M, Bungum M, Spano M, Levine R J and Rylander L. Sperm chromatin structure assay as an independent predictor of fertility in vivo: a case-control study. Int J Androl 2009:.
Henkel R, Kierspel E, Hajimohammad M, Stalf T, Hoogendijk C, Mehnert C, Menkveld R, Schill WB and Kruger T F. DNA fragmentation of spermatozoa and assisted reproduction technology. Reprod Biomed Online 2003:7:477-484.
Huser T, Orme C A, Hollars C W, Corzett M H and Balhorn R. Raman spectroscopy of DNA packaging in individual human sperm cells distinguishes normal from abnormal cells. J Biophotonics 2009:2:322-332.
Krishna C M, Sockalingum G D, Kurien J, Rao L, Venteo L, Pluot M, Manfait M and Kartha VB. Micro-Raman spectroscopy for optical pathology of oral squamous cell carcinoma. Appl Spectrosc 2004:58:1128-1135.
Kubasek W L, Wang Y, Thomas G A, Patapoff T W, Schoenwaelder K H, Van der Sande J H and Peticolas W L. Raman spectra of the model B-DNA oligomer d(CGCGAATTCGCG)2 and of the DNA in living salmon sperm show that both have very similar B-type conformations. Biochemistry (N Y) 1986:25:7440-7445.
Mallidis C, Agbaje I, O'Neill J and McClure N. The influence of type 1 diabetes mellitus on spermatogenic gene expression. Fertility & Sterility 2009a:92:2085-2087.
Mallidis C, Green B D, Rogers D, Agbaje I M, Hollis J, Migaud M, Amigues E, McClure N and Browne R A. Metabolic profile changes in the testes of mice with streptozotocin-induced type 1 diabetes mellitus. Int J Androl 2009b:32:156-165.
Meister K, Schmidt D A, Brundermann E and Havenith M. Confocal Raman microspectroscopy as an analytical tool to assess the mitochondrial status in human spermatozoa. Analyst 2010:135:1370-1374.
Morris I D, Iloft S, Dixon L and Brison D R. The spectrum of DNA damage in human sperm assessed by single cell gel electrophoresis (Comet assay) and its relationship to fertilization and embryo development. Hum Reprod 2002:17:990-998.
Mulholland J, Mallidis C, Agbaje I and McClure N. Male Diabetes and ART Outcome. Reprod Biomed Online submitted:.
Muratori M, Forti G and Baldi E. Comparing flow cytometry and fluorescence microscopy for analyzing human sperm DNA fragmentation by TUNEL labeling. Cytometry Part A: The Journal of the International Society for Analytical Cytology 2008:73:785-787.
Muratori M, Tamburrino L, Tocci V, Costantino A, Marchiani S, Giachini C, Laface I, Krausz C, Meriggiola M C, Forti G et al. Small Variations in Crucial Steps of Tunel Assay Coupled to Flow Cytometry Greatly Affect Measures of Sperm DNA Fragmentation . J Androl 2009:.
Nadalini M, Tarozzi N, Distratis V, Scaravelli G and Borini A. Impact of intracytoplasmic morphologically selected sperm injection on assisted reproduction outcome: a review. Reprod Biomed Online 2009:19 Suppl 3:45-55.
Oliva R, Martinez-Heredia J and Estanyol JM. Proteomics in the study of the sperm cell composition, differentiation and function. Syst Biol Reprod Med 2008:54:23-36.
Olive P L and Banath J P. The comet assay: a method to measure DNA damage in individual cells. Nat Protoc 2006:1:23-29.
O'Neill J, Czerwiec A, Agbaje I, Glenn J, Stitt A, McClure N and Mallidis C. Differences in mouse models of diabetes mellitus in studies of male reproduction. Int J Androl 2010:33:709-716.
Palermo G, Joris H, Devroey P and Van Steirteghem A C. Pregnancies after intracytoplasmic injection of single spermatozoon into an oocyte. Lancet 1992:340:17-18.
Practice Committee of American Society for Reproductive, Medicine. The clinical utility of sperm DNA integrity testing. Fertility & Sterility 2008:90:S178-80.
Santiso R, Tamayo M, Gosalvez J, Meseguer M, Garrido N and Fernandez J L. Simultaneous determination in situ of DNA fragmentation and 8-oxoguanine in human sperm . Fertil Steril 2010:93:314-318.
Schuster K C, Reese I, Urlaub E, Gapes J R and Lendl B. Multidimensional information on the chemical composition of single bacterial cells by confocal Raman microspectroscopy. Anal Chem 2000:72:5529-5534.
Shaposhnikov S, Frengen E and Collins A R. Increasing the resolution of the comet assay using fluorescent in situ hybridization-a review. Mutagenesis 2009:24:383-389.
Speyer B E, Pizzey A R, Ranieri M, Joshi R, Delhanty J D and Serhal P. Fall in implantation rates following ICSI with sperm with high DNA fragmentation. Hum Reprod 2010:25:1609-1618.
Swain R J and Stevens M M. Raman microspectroscopy for non-invasive biochemical analysis of single cells. Biochem Soc Trans 2007:35:544-549.
Tomlinson M J, Moffatt 0, Manicardi G C, Bizzaro D, Afnan M and Sakkas D. Interrelationships between seminal parameters and sperm nuclear DNA damage before and after density gradient centrifugation: implications for assisted conception. Hum Reprod 2001:16:2160-2165.
Vidyasagar M S, Maheedhar K, Vadhiraja B M, Fernendes D J, Kartha V B and Krishna C M. Prediction of radiotherapy response in cervix cancer by Raman spectroscopy: a pilot study. Biopolymers 2008:89:530-537.
World Health Organisation. Laboratory manual for the examination of human semen and sper-cervical interaction. 1999. Cambridge University Press, United Kingdom.

1. A method for detecting sperm nuclear DNA (nDNA) in a sperm sample by Raman microspectroscopy, the method comprising
a) providing a sperm sample;
b) irradiating sperm with a laser beam;
c) collecting and collating the resulting Raman signals; and
d) obtaining the Raman spectrum.

2. The method of claim 1, which is for assessing the structure and/or status of sperm nDNA and/or integrity of sperm nDNA.

3. The method of claim 1 or 2, which is for visualizing intact, damaged and/or partially damaged sperm nDNA.

4. The method of any one of the preceding claims, wherein the detection of sperm nDNA, the assessment of the structure and/or status and/or integrity of sperm nDNA, or visualization of intact, damaged and/or partially damaged sperm nDNA comprises determining DNA damage in sperm nDNA, in particular changes of the PO₄ backbone, nucleotide modifications and/or nucleotide dimerizations in sperm nDNA.

5. The method of claim 2, 3 or 4, wherein assessing the structure and/or status of sperm nDNA and/or integrity of sperm nDNA, visualizing DNA damage in sperm nDNA or assessing the structure and/or status and/or integrity of sperm nDNA allows distinguishing intact from damaged and/or partially damaged nDNA.

6. The method of any one of the preceding claims, which allows selecting normal from abnormal sperm comprised by a sperm sample on the basis of intact, damaged and/or partially damaged nDNA.

7. The method of any one of the preceding claims, wherein Raman microspectroscopy is Confocal Raman Microspectroscopy.

8. The method of any one of the preceding claims, wherein a single point scanning of the sperm sample is performed, preferably two scans.

9. The method according to any one of the preceding claims, wherein the sperm nDNA is intact, damaged and/or partially damaged.

10. The method according to any one of the preceding claims, wherein the laser wavelength is in the range of 500 nm to 800 nm.

11. The method according to claim 10, wherein the laser wavelength is 633 nm or 785 nm.

12. The method according to any one of the preceding claims, wherein when the wavelength is 633 nm the sample is irradiated one or two times between 5 and 10 seconds.

13. The method according to any one of the preceding claims further comprising
e) comparing the spectrum obtained in step d) with comparative Raman spectra of intact sperm and/or damaged and/or partially damaged nDNA; and
f) determining whether the nDNA of the sperm is intact and/or damaged and/or partially damaged.

14. The method according to claim 13, wherein in step f) the evaluation of the region 1020-1100 cm−1 of the Raman spectra is performed.

15. The method according to any one of preceding claims, wherein the presence of a main single spectral peak in the region of 1100 cm⁻¹ to 1020 cm⁻¹ of the Raman spectrum obtained in step d) is indicative of the presence of intact nDNA in the sperm.

16. The method according to claim 15, wherein the main single spectral peak in the region between 1100 cm⁻¹ to 1080 cm⁻¹ is at 1092±5 cm⁻¹, preferably at 1092 cm⁻¹.

17. The method according to claim 15 or 16, wherein the presence of the main peak is associated with intact DNA PO₄ backbone.

18. The method according to any one of claims 1-15, wherein the presence of a main spectral peak a in the region of 1050-1020 cm⁻¹, preferably a main spectral peak at 1042 cm⁻¹ of the Raman spectrum obtained in step d) is indicative of the presence of damaged nDNA in the sperm sample.

19. The method according to claim 18, wherein the presence of the main peak is associated with damaged DNA PO₄ backbone.

20. The method according to any one of the preceding claims, wherein the presence of a peak in the region of 1100 cm⁻¹ to 1080 cm⁻¹ and of a peak in the region at 1050-1020 cm⁻¹ of the Raman spectrum obtained in step d) is indicative of the presence of intact and/or damaged nDNA in the sperm sample, respectively.

21. A method for screening sperm for in vitro fertilization (or artificial reproduction treatment or ICSI), said method comprising
determining intact and/or damaged and/or partially damaged nDNA according to the method of any one of the preceding claims, wherein intact nDNA indicates a sperm suitable for in vitro fertilization (or artificial reproduction treatment) and damaged or partially damaged nDNA indicates that the sperm is not suitable for in vitro fertilization (or artificial reproduction treatment).

22. The method according to any one of the preceding claims, wherein the sperm is of a male mammalian, bird, fish, amphibian or reptile.

23. The method according to claim 24, wherein the mammalian is selected from human, calf, bull, dog, cat, swine, horse, camel.

24. The method according to claim 24, wherein the bird is selected from turkey, chicken, fowl

25. Use of Raman microspectroscopy for determining as to whether sperm nDNA is intact, damaged and/or partially damaged.

26. A kit or system for performing the method or use of any one of the preceding claims.
